(19) United States
(12) Patent Application Publication
(10) Pub. No.: US 2017/0169704 A1
(43) Pub. Date: Jun. 15, 2017

(54) METHOD AND DEVICE FOR TRIGGERING PEDESTRIAN PROTECTION MEANS AND/OR PEDESTRIAN WARNING MEANS

(71) Applicant: Robert Bosch GmbH, Stuttgart (DE)

(72) Inventors: Folko Flehmig, Stuttgart (DE); Johannes Ruenz, Renningen (DE); Michael Schulz, Sinsheim (DE); Roland Galbas, Ludwigsburg (DE); Volker Hofsaess, Moeglingen (DE)

(21) Appl. No.: 15/371,732

(22) Filed: Dec. 7, 2016

(30) Foreign Application Priority Data
Dec. 9, 2015 (DE) 102015224739.2

(51) Int. Cl. G08G 1/005; B60R 21/34

(52) U.S. Cl. CPC G08G 1/005; B60R 21/34

(57) ABSTRACT

A method is described for triggering pedestrian protection means and/or pedestrian warning means for a vehicle, in which objects in a surrounding area of the vehicle are detected, pedestrians are identified from the detected objects, a situation is analyzed as a function of the detected objects and a model assumption, the pedestrian protection means or pedestrian warning means are triggered as a function of the situation analysis, features of the identified pedestrians are ascertained, and the model assumption is selected or set up as a function of the ascertained features.

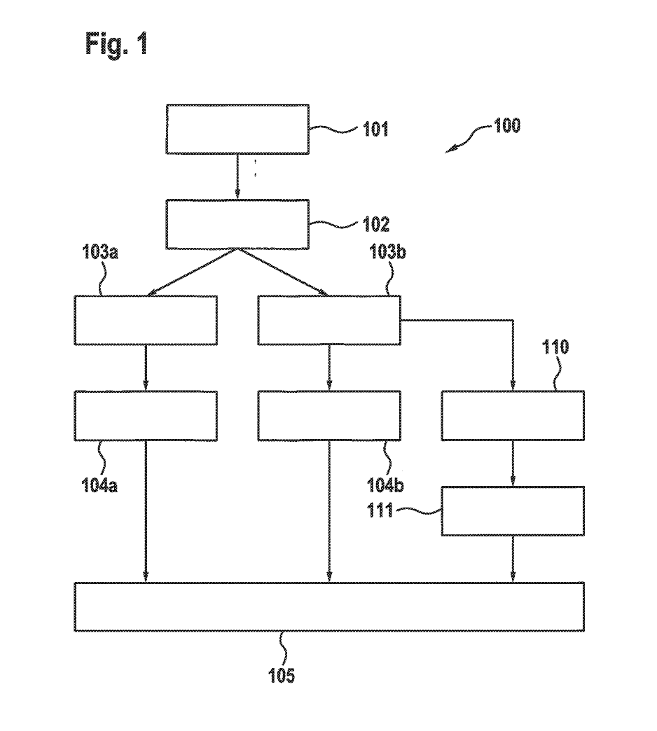

### BACKGROUND INFORMATION

Current methods or devices for triggering pedestrian protection means or pedestrian warning means are based on model assumptions for the behavior of identified pedestrians.

These systems have the disadvantage that they use, as their basis, the same model assumptions for all pedestrians despite the fact that the behavior of pedestrians sometimes differs significantly. This becomes especially apparent in the behavior patterns of children in road traffic in comparison with the behavior patterns of adults.

### SUMMARY

Against this background, the present invention provides a method for triggering pedestrian protection means or pedestrian warning means for a vehicle, in which objects are detected in a surrounding area of the vehicle and pedestrians are identified from the detected objects, a situation is analyzed as a function of the detected objects and a model assumption, the pedestrian protection means or the pedestrian warning means are triggered as a function of the situation analysis, features of the identified pedestrians are ascertained, and the model assumption is selected or set up as a function of the ascertained features.

Because of the model assumptions selected or set up from the ascertained features, the prediction of the pedestrian behavior is improved since it is no longer a general model assumption that forms the basis of the situation analysis, and thus ultimately of the decision for triggering pedestrian protection means or pedestrian warning means, but a special model assumption that is adapted to the respective ascertained features of the identified pedestrians.

In this context, pedestrian protection means denote means that keep a pedestrian from harm or at least reduce the harm in the event of a collision with the vehicle. More specifically, this describes active pedestrian protection systems such as automatic emergency braking systems, automatic evasion systems, automatic combined braking and evasion systems or external airbags for lessening the harm to pedestrians that results from an accident.

In the case at hand, pedestrian warning means are means that lend themselves to warning the driver of the vehicle or the affected pedestrian of a looming collision. In particular, they denote acoustic or optical means.

To sense the environment, the vehicle may avail itself of an environment sensor system in the case at hand. Conceivable sensor types that may be used for this purpose, individually or in combination, are camera, radar, lidar or also ultrasonic systems. In this context, sensing the environment also means the tracking of detected objects.

In the present case, a model assumption means a prediction, such as in the form of a calculating rule or an algorithm, that is suitable for ascertaining parameters or features of the identified pedestrians in the future, such as calculating a presence probability in the future in a certain region on the basis of movement features of the identified pedestrian, for example. The model assumptions may be predefined, for instance as the result of accident research. It is also conceivable that the model assumptions are set up as a function of the ascertained features.

In the present case, features describe the following features of an identified pedestrian, in particular:
height;
step length;
step frequency;
movement state, in particular standing, ambulating, walking, running;
talking on the telephone;
wearing headphones.

According to one specific embodiment of the method, the identified pedestrians are assigned to a cluster as a function of the ascertained features, and in the step of analyzing the situation, trigger thresholds for the pedestrian protection means or the pedestrian warning means are adapted as a function of the assigned cluster.

The trigger thresholds for pedestrian protection means or pedestrian warning means are to be set in such a way that both the false-positive rate and the false-negative rate are as low as possible.

Excessive false-positive rates lead to a lower acceptance of the safety system since the safety system may possibly be triggered too often when no triggering would have been necessary.

Excessive false-negative rates, on the other hand, lead to non-triggering of the safety system although triggering would be warranted. This in turn increases the danger posed by a vehicle equipped with such a safety system.

Here, a cluster means a group of pedestrians whose ascertained features exhibit a predefined similarity. The cluster of rapidly moving pedestrians, whose feature of speed lies above a minimum speed, would be one example.

According to a further specific embodiment of the present method, the trigger thresholds are adapted in such a way that, depending on the assigned cluster, false triggering of the pedestrian warning means and/or the pedestrian protection means is more likely.

This specific embodiment of the method is based on the recognition that users of a vehicle equipped with such safety systems accept a higher false-positive rate in the case of certain pedestrian clusters. This applies particularly to pedestrians allocated to a cluster to which children are allocated.

According to a further specific embodiment of the present invention, different trigger thresholds apply to the triggering of the pedestrian protection means and the pedestrian warning means.

Because of this specific embodiment, it is possible to differentiate between the triggering of pedestrian protection means and the triggering of pedestrian warning means in an uncomplicated manner. This specific embodiment is based on the understanding that a triggering of pedestrian protection means, in particular a triggering of active pedestrian protective means, is perceived as a serious intervention in the vehicle handling and leads to a reduced acceptance of the pedestrian protection means in the case of an excessive false-positive rate. The triggering of pedestrian warning means, on the other hand, is perceived as a less serious intervention in the vehicle handling and may therefore have a higher false-positive rate. A special influence on the occurrence of the false-positive rate is exerted by the selection of the trigger threshold.

A further aspect of the present invention is a device for triggering pedestrian protection means or pedestrian warning means that is developed in such a way that the device executes the steps of the present method.

Such a device may be developed as part of a device for actuating passenger protection means, such as an airbag control device. It is also conceivable that the presented device is realized as part of a device for an ESP control, such as an ESP control unit. However, the device according to the present invention is not to be considered restricted to these control devices.

A further aspect of the present invention is a computer program that is set up for executing the steps of the present method.

Another aspect of the present invention is also a machine-readable storage medium on which this computer program is stored.

### BRIEF DESCRIPTION OF THE DRAWING

The FIGURE shows a flow diagram of a specific embodiment of a method of the present invention.

### DETAILED DESCRIPTION

The FIGURE shows a flow diagram of a specific embodiment of a method 100 of the present invention. In step 101, an environment sensor of the vehicle detects objects in the environment of the vehicle. In step 102, pedestrians 103b are identified from the detected objects. Remaining objects 103a are tracked separately. In steps 104a, 104b, first features are ascertained such as pose and dynamics of the detected objects. In step 105, the detected situation is analyzed as a function of the detected objects and a model assumption as to whether the pedestrian protection means or the pedestrian warning means are triggered. Advantageous in the illustrated method are in particular the additional steps 110 and 111. In step 110, further features of the identified pedestrians are ascertained. In step 111, a model assumption is set up or selected as a function of the ascertained further features. This model assumption is then used as the basis of the situation analysis in step 105.

What is claimed is:

1. A method for triggering at least one of a pedestrian protection means and a pedestrian warning means for a vehicle, comprising:
detecting at least one object in a surrounding area of the vehicle;
identifying at least one pedestrian from the at least one detected object;
analyzing a situation as a function of the at least one detected object and a model assumption; and
triggering one of the pedestrian protection means and the pedestrian warning means as a function of the situation analysis, wherein at least one feature of the at least one identified pedestrian is ascertained and the model assumption is one of selected and set up as a function of the at least one ascertained feature.

2. The method as recited in claim 1, wherein the at least one identified pedestrian is assigned to a cluster as a function of the ascertained features, and wherein in the step of analyzing, at least one trigger threshold for at least one of the pedestrian protection means and the passenger warning means are adapted as a function of the assigned cluster.

3. The method recited in claim 2, wherein the at least one trigger threshold is adapted in such a way that, depending on the assigned cluster, a false triggering of at least one of the pedestrian warning means and the pedestrian protection means is more likely.

4. The method as recited in claim 3, wherein the false triggering is more likely if the at least one identified pedestrian is assigned to a cluster to which at least one child is assigned.

5. The method as recited in claim 2, wherein different trigger thresholds apply to the triggering of the pedestrian protection means and the pedestrian warning means.

6. The method as recited in claim 1, the at least one ascertained feature includes includes at least one of the following variables:
height;
step length;
step frequency;
movement state;
talking on the telephone; and
wearing headphones.

7. The method as recited in claim 6, wherein the movement state includes one of standing, ambulating, walking, and running.

8. A device for triggering at least one of a pedestrian protection means and a pedestrian warning means, comprising:
an arrangement for detecting at least one object in a surrounding area of the vehicle;
an arrangement for identifying at least one pedestrian from the at least one detected object;
an arrangement for analyzing a situation as a function of the at least one detected object and a model assumption; and
an arrangement for triggering one of the pedestrian protection means and the pedestrian warning means as a function of the situation analysis, wherein at least one feature of the at least one identified pedestrian is ascertained and the model assumption is one of selected and set up as a function of the at least one ascertained feature.

9. A computer program which is developed to execute a method for triggering at least one of a pedestrian protection means and a pedestrian warning means for a vehicle, comprising:
detecting at least one object in a surrounding area of the vehicle;
identifying at least one pedestrian from the at least one detected object;
analyzing a situation as a function of the at least one detected object and a model assumption; and
triggering one of the pedestrian protection means and the pedestrian warning means as a function of the situation analysis, wherein at least one feature of the at least one identified pedestrian is ascertained and the model assumption is one of selected and set up as a function of the at least one ascertained feature.

10. A machine-readable storage medium on which the computer program as recited in claim 9 is stored.
